(19) United States
(12) Patent Application Publication
(10) Pub. No.: US 2026/0362322 A1
(43) Pub. Date: Nov. 12, 2026

(54) METHOD AND APPARATUS FOR ENERGY AWARE EDGE SERVICE PROVISIONING AND EDGE APPLICATION SERVER (EAS) DISCOVERY

(71) Applicant: InterDigital Patent Holdings, Inc., Wilmington, DE (US)

(72) Inventors: Debashish Purkayastha, Eagleville, PA (US); Michel Roy, Candiac (CA); Kevin Di Lallo, Laval (CA); Michael Starsinic, Newtown, PA (US); Taimoor Abbas, Sainte-Julie (CA); Atle Monrad, Froland (NO); Achref Methenni, Montreal (CA)

(73) Assignee: InterDigital Patent Holdings, Inc., Wilmington, DE (US)

(21) Appl. No.: 19/201,574

(22) Filed: May 7, 2025

(51) Int. Cl. H04W 52/02; H04W 8/00; H04W 48/20; H04W 76/10

(52) U.S. Cl. CPC H04W 52/0212; H04W 8/005; H04W 48/20; H04W 76/10

(57) ABSTRACT

Methods, systems, and apparatuses for enhancing edge enabler layer are provided in this disclosure. The edge enabler layer selects an edge application server (EAS) for an edge enabler client (EEC) based on energy consumption and/or one or more energy efficiency criteria. A registration of an edge enabler server (EES) and/or an EAS may include energy information. An edge enabler node may provision one or more services to the EEC based on the energy information. The edge enabler node may perform EAS discovery based on the energy information. The edge enabler node may use predicted energy consumption of one or more core network nodes and/or EASs for EAS discovery and service provisioning. The edge enabler node may monitor an actual energy consumption of the one or more core network nodes and/or EASs and trigger application context relocation based on the actual energy consumption and one or more energy thresholds.

### BACKGROUND

Edge computing requires efficient processing at a network edge. The network edge includes various edge nodes such as edge application servers and edge enabler servers. Efficient processing is required to support low-latency high performance applications on user devices and application clients. However, executing applications on the edge nodes consumes significant energy in computing and communication. With an increasing number of user devices and application clients, the energy consumption also increases. Therefore, there is a need for a technique to monitor an energy consumption of the edge nodes to provide sustainable performance.

### SUMMARY

In an embodiment of the present disclosure, a method performed by a first network node is provided. The method comprises receiving, from a wireless transmit/receive unit (WTRU), an application server discovery request indicating energy related information. The energy related information comprises one or more energy consumption goals and an energy awareness indication. The method comprises obtaining, from a second network node, predicted communication-related energy consumption information indicative of a predicted energy consumption for establishing and maintaining a communication session between the WTRU and one or more network nodes. The method comprises obtaining, from a third network node, computing-related energy consumption information indicative of a plurality of energy limits associated with an energy consumed by a plurality of application servers. The method includes determining, based on the predicted communication-related energy consumption information and the computing-related energy consumption information, a respective predicted energy consumption by each application server of the plurality of application servers. The method includes selecting one or more application servers from the plurality of application servers for which the predicted energy consumption meets the one or more energy consumption goals. The method includes transmitting, to the WTRU, an application server discovery response indicating the one or more application servers and the respective predicted energy consumption associated with each application server of the one or more application servers.

In an embodiment, the one or more energy consumption goals include at least one of: an energy goal for the first network node, an energy goal for an application server, or a preferred source of energy used by the application server.

In an embodiment, the energy awareness indication includes at least one of: an indication of one or more WTRU energy capabilities, an indication for selecting an energy aware application server, an indication of one-time provisioning of the first network node, or an indication of continuous monitoring.

In an embodiment, the method comprises receiving, from the WTRU, an application server provisioning request indicating a selected application server from the one or more application servers.

In an embodiment, the method comprises determining that the energy awareness indication includes an indication of continuous monitoring. The method comprises receiving, from the second network node, an actual communication-related energy consumption information indicative of an actual energy consumed by the one or more network nodes in establishing and maintaining the communication session between the WTRU and an application server. The method comprises receiving, from the third network node, an actual computing-related energy consumption information indicative of an actual energy consumed by the selected application server in the communication session. The method comprises continuously monitoring an actual energy consumption associated with the communication session based on the actual communication-related energy consumption information and the actual computing-related energy consumption information.

In an embodiment, the method comprises comparing the actual energy consumption associated with the communication session with an energy limit associated with the communication session. The method comprises transmitting a notification to the WTRU when the actual energy consumption associated with the communication session exceeds the energy limit associated with the communication session.

In an embodiment, the method comprises receiving, from the WTRU, an application context relocation (ACR) request including an indication of a target application server and an energy profile associated with the target application server;

In an embodiment, the method comprises determining that the predicted energy consumption associated with the target application server meets the one or more energy consumption goals. The method comprises transferring a context associated with the first network node to a target edge enabler server associated with the target application server. The method includes transferring a source application server context associated with the selected application server to the target application server. The method includes transmitting, to the WTRU, an ACR response indicative of successful ACR procedure.

In an embodiment, the method comprises transmitting, to an edge configuration server, a registration request including an indication of support for one or more energy aware services.

In an embodiment, the first network node is an edge enabler server.

In an embodiment, the WTRU includes an edge enabler client.

In an embodiment of the present disclosure, a first network node comprising a transceiver and a processor is provided. The transceiver and the processor of the first network node are configured to receive, from a WTRU, an application server discovery request indicating energy related information. The energy related information comprises one or more energy consumption goals and an energy awareness indication. The transceiver and the processor of the first network node are configured to obtain, from a second network node, predicted communication-related energy consumption information indicative of a predicted energy consumption for establishing and maintaining a communication session between the WTRU and one or more network nodes. The transceiver and the processor of the first network node are configured to obtain, from a third network node, computing-related energy consumption information indicative of a plurality of energy limits associated with an energy consumed by a plurality of application servers. The transceiver and the processor of the first network node are configured to determine, based on the predicted communication-related energy consumption information and the computing-related energy consumption information, a respective predicted energy consumption by each application server of the plurality of application servers. The transceiver and the processor of the first network node are configured to select one or more application servers from the plurality of application servers for which the predicted energy consumption meets the one or more energy consumption goals. The transceiver and the processor of the first network node are configured to transmit, to the WTRU, an application server discovery response indicating the one or more application servers and the respective predicted energy consumption associated with each application server of the one or more application servers.

In an embodiment, the one or more energy consumption goals include at least one of: an energy goal for the first network node, an energy goal for an application server, or a preferred source of energy used by the application server.

In an embodiment, the energy awareness indication includes at least one of: an indication of one or more WTRU energy capabilities, an indication for selecting an energy aware application server, an indication of one-time provisioning of the first network node, or an indication of continuous monitoring.

In an embodiment, the transceiver and the processor of the first network node are configured to receive, from the WTRU, an application server provisioning request indicating a selected application server from the one or more application servers.

In an embodiment, the transceiver and the processor of the first network node are configured to determine that the energy awareness indication includes an indication of continuous monitoring. The transceiver and the processor of the first network node are configured to receive, from the second network node, an actual communication-related energy consumption information indicative of an actual energy consumed by the one or more network nodes in establishing and maintaining the communication session between the WTRU and an application server. The transceiver and the processor of the first network node are configured to receive, from the third network node, an actual computing-related energy consumption information indicative of an actual energy consumed by the selected application server in the communication session. The transceiver and a processor of the first network node are configured to continuously monitor an actual energy consumption associated with the communication session based on the actual communication-related energy consumption information and the actual computing-related energy consumption information.

In an embodiment, the transceiver and the processor of the first network node are configured to: compare the actual energy consumption associated with the communication session with an energy limit associated with the communication session, and transmit a notification to the WTRU when the actual energy consumption associated with the communication session exceeds the energy limit associated with the communication session.

In an embodiment, the transceiver and the processor of the first network node are configured to: receive, from the WTRU, an application context relocation (ACR) request including an indication of a target application server and an energy profile associated with the target application server. The transceiver and the processor of the first network node are configured to determine that the predicted energy consumption associated with the target application server meets the one or more energy consumption goals. The transceiver and the processor of the first network node are configured to transfer a context associated with the first network node to a target edge enabler server associated with the target application server. The transceiver and the processor of the first network node are configured to transfer a source application server context associated with a source application server (e.g., the selected application server) to the target application server. The transceiver and the processor of the first network node are configured to transmit, to the WTRU, an ACR response indicative of successful ACR procedure.

In an embodiment, the transceiver and the processor of the first network node are configured to: transmit, to an edge configuration server, a registration request including an indication of support for one or more energy aware services. In an embodiment, the first network node is an edge enabler server.

In an embodiment, the WTRU includes an edge enabler client.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like element.

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example edge computing application framework according to one or more embodiments;

FIG. 3 is a system diagram illustrating an edge enabler layer architecture according to one or more embodiments;

FIG. 4 is a flow diagram illustrating an example method for service provisioning enhanced with energy information according to one or more embodiments;

FIG. 5 is a flow diagram illustrating an example enhanced edge application server discovery procedure enhanced with energy information according to one or more embodiments;

FIG. 6 is a flow diagram illustrating an example enhanced edge application server discovery procedure enhanced with energy information according to one or more embodiments; and

FIG. 7 is a flow chart illustrating an example application server discovery process according to one or more embodiments.

### DETAILED DESCRIPTION

As discussed herein, one or more abbreviations in the following (non-exhaustive) list, shown in Table 1, may be used herein.

TABLE 1

| | |
|---|---|
| AC | Application Client |
| ACK | Acknowledgement |
| AF | Application Function |
| API | Application Program Interface |
| AS | Application Server |
| ASP | Application Service Provider |
| CN | Core Network |
| EAS | Edge Application Server |
| ECS | Edge Configuration Server |
| ECSP | Edge Computing Service Provider |
| EDN | Edge Data Network |
| EE | Energy Efficiency |
| EES | Edge Enabler Server |
| EES | Energy Efficiency Services |
| EEL | Edge Enabler Layer |
| E2E | End to End |
| MNO | Mobile Network Operator |
| NACK | Negative ACK |
| OA&M | Operations Administration and Management |
| UE | User Equipment |
| UPF | User Plane Function |
| WLAN | Wireless Local Area Networks and related |
| | technologies (IEEE 802.xx domain) |

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

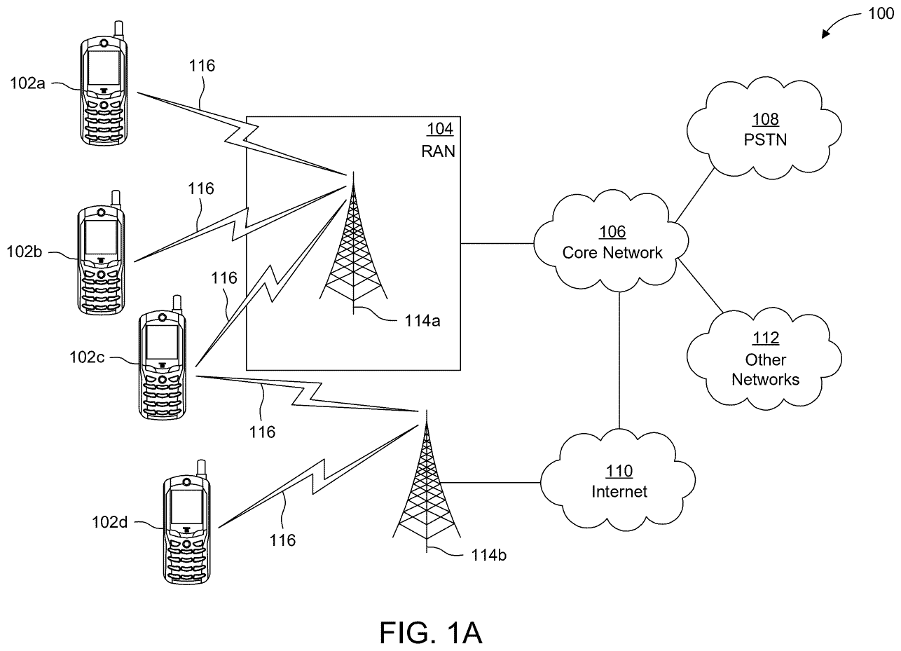

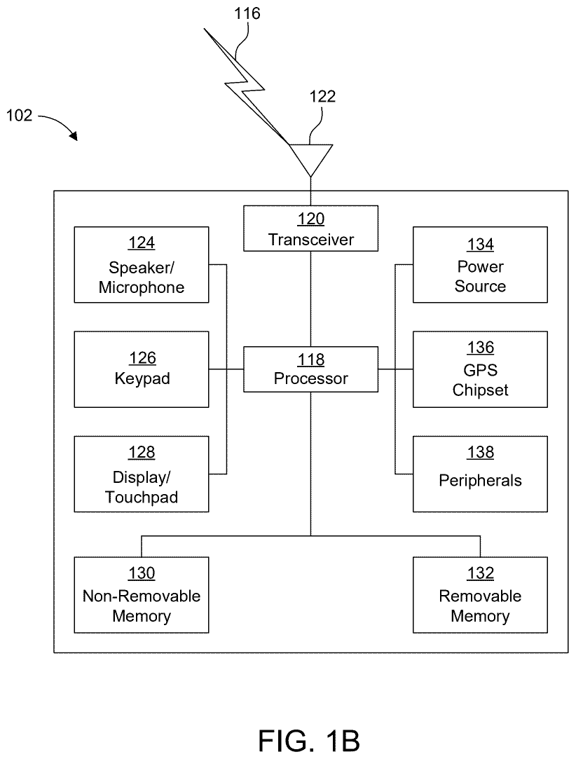

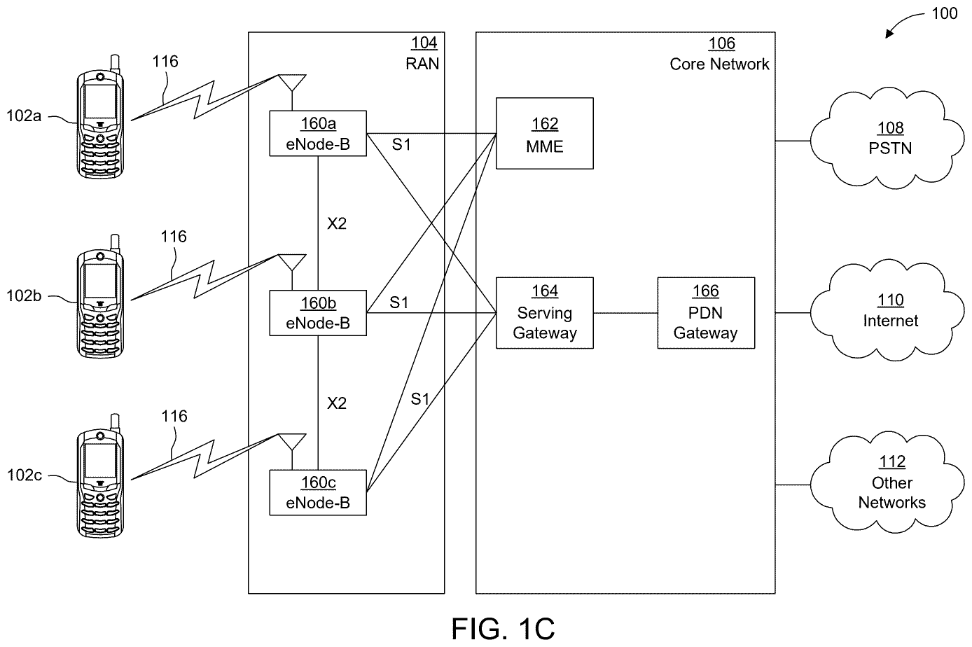

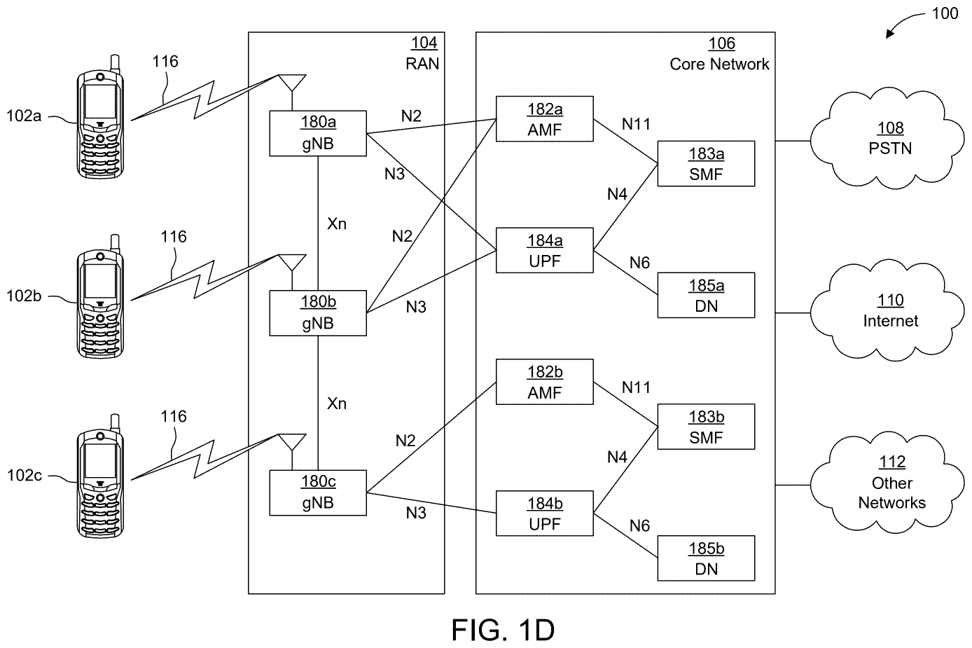

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Various technical reports (TRs) in 3rd generation partnership project (3GPP) relate to energy efficiency. In an example, TR 22.882 is a 3GPP technical specification group service and system aspects (TSG SA) (SA1) study item on energy efficiency as a service criterion (e.g., in Release 19). The scope of this study item includes various enhancements to energy efficiency of fifth generation (5G) networks and application service enabler aspects. The study item includes defining and supporting energy criteria as a part of communication service to users and to various application services. The study item also includes supporting information exposure of systematic energy consumption or level of energy to vertical customers. For instance, consolidated requirements include that 5G system shall provide a mechanism to support selection of an application server based on energy consumption information associated with a set of application servers. The consolidated requirements include that subject to operator's policy and agreement with 3rd party, the 5G system shall be able to expose information on energy consumption for serving this 3rd party. The consolidated requirements include that 5G system shall support a means to expose energy consumption to authorized third parties for services, including energy consumption information related to a condition of energy credit limit (e.g. when the energy consumption is reaching the energy credit limit).

In an example, TR 22.883, PH2 Rel 20, is a study on energy efficiency as service criteria in Phase 2 (Release 20). This study item includes information exposure of energy-related characteristics of the network for the communication service (i.e. energy consumption, energy supply mix, carbon footprint, energy capacity and availability conditions) to authorized users or authorized 3rd parties. The study item includes potential dynamic adjustments of a delivered communication service from a 5G system perspective (including service performance adjustments) resulting from changes of energy-related characteristics of this service. In an example, SA2 23.700-66 is a study in SA2, that identifies the following key issues: network energy related information exposure, subscription and policy control to support energy efficiency and energy saving as service criteria, and 5GS enhancements for network energy saving and efficiency. The study concluded with these following conclusions: a new network functionality is defined to collect and calculate the energy related information and expose to the authorized consumer subject to operator's policy, one or more consumer network functions (NFs) including 5GC NFs and/or application function (AF), may request the energy consumption information exposure with reporting request. A key issue included subscription data in a unified data management (UDM) and/or unified data repository (UDR) to include energy saving subscription information per WTRU to assist the network to perform one or more energy saving strategies for the WTRU. An NF profile may be extended (e.g. to include energy related information or reuse existing NF profile parameters) to allow an operator to influence NF discovery and selection, based on their energy strategy a user plane (UP) path of a protocol data unit (PDU) session may be adjusted.

In an example, SA6 energy efficiency is a new Rel-20 5GA feature. A new SID has been proposed. The SID proposes to study architectural and functional enhancement on SA6 application enablers and/or services. This includes enhancements to common application programming interface (API) framework (CAPIF) with energy requirements, energy efficiency and energy saving in SA6 northbound interfaces, e.g., potential enhancements to edge enabler server (EES) capability exposure (e.g., for edge application server (EAS) discovery, re-discovery, and/or relocation), potential enhancements to existing service enabler architecture layer SEAL services with energy requirements (e.g. enhanced location management (LM) service, application data analytics enablement (ADAE) analytics for energy efficiency (EE), etc.), need for a potential new SEAL service on energy optimization (e.g. assist artificial intelligence and/or machine learning (AIML) client selection to improve energy efficiency, assist EAS selection, adjust a location services quality of service (LCS QoS) to reduce energy consumption), and energy efficiency and energy saving notification (e.g. assist consumer (e.g. VAL server, SEAL server) to adjust operation and/or configuration dynamically to save energy and improve energy efficiency).

A 3GPP SA6 edge computing application framework defines an architecture for various edge-aware applications. The edge-aware clients can communicate with the ECS and the EES to obtain information about available edge applications and may continually update the obtained information to ensure that optimal edge services are used. The existing edge enablement framework capabilities allow discovery of the edge services based on location, connectivity and offered services, but do not provide a capability to optimally discover edge services based on their energy consumption. Without the ability to consider energy information when determining the best EAS for an EEC to use, energy consumption of the 5GS may be higher than what it would be if the EAS selection could be based on energy information. Therefore there is a need for enhancing the edge enablement layer to allow energy consumption information to be considered in edge enablement procedures.

Various embodiments of the present disclosure enhance a service enabler layer with various energy capabilities. In an embodiment of the present disclosure, a method for energy efficient EAS selection by EES is provided. An EES or an application function (AF) may register with an edge configuration server (ECS) and/or an AF, with information about one or more capabilities (e.g., EES energy capabilities) to support one or more energy aware services, e.g. select an application server (AS) based on an energy consumption budget and/or select an AS based on a WTRU battery power. The EES may receive AS energy aware service capability information such as average energy consumption rating, average energy consumption per service, source of energy, time window for cheap and/or renewable energy, and/or capability to scale up and/or scale down service level to preserve WTRU battery power etc., when the AS registers with EES. The EES may receive an AS discovery request from a WTRU and/or edge enabler client (EEC), which may include WTRUs requirement to select an AS based on one or more energy criteria, such as WTRU energy goal, WTRU energy efficient capability and/or WTRU identity, and/or device identity etc. The EES may request information from core network (CN) about the WTRU and/or one or more users' subscription to one or more energy aware services, battery power of the WTRU, end to end energy consumption information, and/or energy budget for the WTRU and may request operations administration and management (OAM) function to obtain information about one or more energy limit for one or more EASs and/or one or more nodes in the CN, and/or a source of energy etc. The EES may receive, from the CN, subscription information about the WTRU and/or the one or more users' subscription to the one or more energy aware services, one or more battery power thresholds and/or one or more profiles of the WTRU, end to end energy consumption information, and/or one or more energy budgets for the WTRU etc. The EES may select one or more EASs based on the information received from the CN, the OAM and the EAS registration, which may support one or more energy requirements of the WTRU as per subscription information, an allowed energy budget, an allowed service quality level etc. The EES may send a list of the one or more selected EASs with energy consumption information to the WTRU and/or the EEC. The EES may receive an application context relocation (ACR) request from WTRU and/or the EEC, indicating that an ACR is required because energy consumption degraded and/or because of an indication of an EAS with a better energy consumption. The EES may transfer the EAS and/or the EEC context to the target EAS and target EES respectively, update the subscription information for the target EAS and target EES. In an example, the EES may send an ACR response to the EEC, indicating that the ACR procedure is successful with the target EAS and send the target EAS energy profile. In an example, the EES may send an ACR rejection to the EEC, indicating that the ACR procedure is unsuccessful and may include the cause code and/or reason for rejection.

Various embodiments of the present disclosure relate to a service enabler layer. In 3GPP SA6, an edge computing application architecture is provided for one or more edge-aware applications. An edge-aware client and/or one or more server applications have the knowledge of edge infrastructure, and they could continually optimize the one or more edge-aware applications based on the edge infrastructure state.

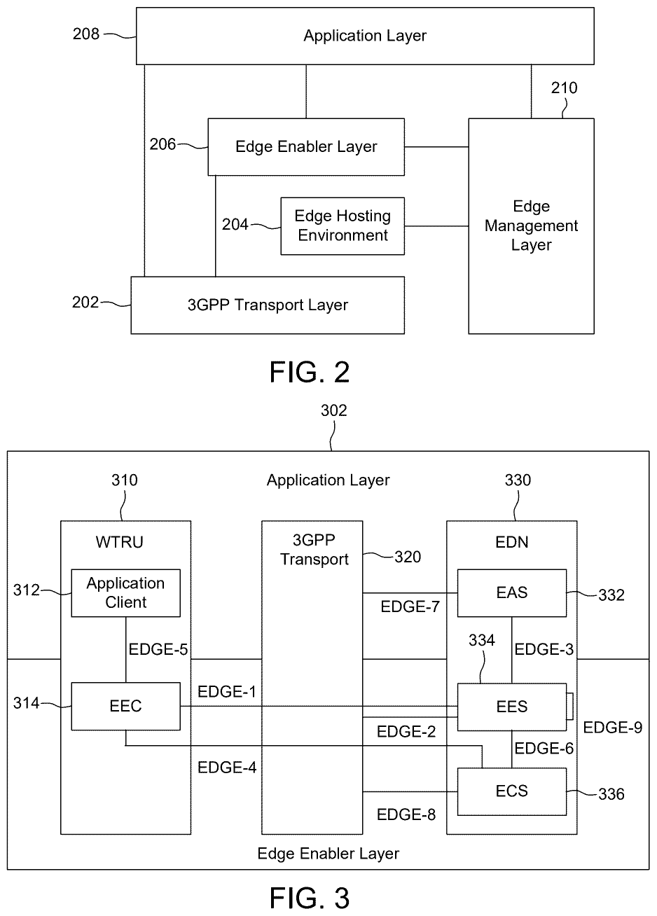

Referring now to FIG. 2, an example edge computing application framework is shown according to one or more embodiments. The edge computing application framework includes a transport layer 202, an edge hosting environment 204, an edge enabler layer 206, an application layer 208, and an edge management layer 210.

The application layer 208 may include one or more edge-aware client and server applications developed by various application developers. The edge enabler layer 206 may include one or more edge infrastructure components (e.g., nodes and/or apparatuses) that enable one or more edge-aware client and server modules to monitor and/or handle one or more edge infrastructure events such as network state changes, and/or edge relocation, etc. The edge hosting environment 204 may include edge compute optimized hardware infrastructure that hosts the one or more edge applications, hosted in an edge data network (EDN) that is connected to a local user plane function (UPF) in a service provider network. The edge management layer 210 may include management and orchestration of the one or more edge applications and/or infrastructure to support highly dynamic edge application architecture. The transport layer 202 may include service provider network that connects one or more edge clients with one or more backend servers. The edge enabler layer (EEL) 206 includes three main components: an edge enabler client (EEC), an edge enabler server (EAS), and/or an edge configuration server (ECS). The EEC supports one or more application clients to discover one or more application servers, detects one or more WTRU mobility events, and/or retrieves configuration information to enable communication with the one or more application servers. The EES enables one or more application clients (ACs) to connect to one or more application servers by registering and/or dynamically instantiating the one or more application servers as needed and/or supports application context relocation. The ECS provides identity and connectivity information of one or more registered EAS servers to one or more EECs. The ECS supports registration of one or more EESs and interfaces with the 3GPP core network for accessing the capabilities of network functions. In an example, the 3GPP SA6 provides edge reference architecture with one or more reference points for enabling edge applications. The SA6 defines the one or more reference points and one or more interfaces between the EEL and the one or more application layer components.

Referring now to FIG. 3, an example edge enabler layer architecture is shown according to one or more embodiments. The edge enabler layer architecture includes an edge enabler layer 301 and an application layer 302. The edge enabler layer architecture includes a wireless transmit/receive unit (WTRU) 310 including an application client 312 and an EEC 314. The edge enabler layer architecture includes a transport layer 320. The edge enabler layer architecture includes an edge data network (EDN) 330 including an EAS 332, an EES 334, and an ECS 336.

One or more EDGE-2, EDGE-7, and EDGE-8 reference points may be associated with communications between one or more APIs of one or more functional elements included in the edge enablement layer and one or more APIs of the functional elements of the 3GPP core network. The one or more EDGE-2 reference points are associated with communications between the one or more APIs of the EES and the one or more APIs of the one or more functional elements of the 3GPP core network, including communications for retrieval of network capability information. The edge enabler layer architecture supports access via SCEF and NEF APIs as defined in 3GPP TS 23.501, 3GPP TS 23.502, 3GPP TS 29.522, 3GPP TS 23.682, 3GPP TS 29.122; and/or direct access to one or more core network functions with the EES deployed within a mobile network operator (MNO) trust domain. The one or more EDGE-7 and EDGE-8 reference points are associated with communications between the one or more APIs of the EAS and ECS respectively and the one or more APIs of the one or more functional elements of the 3GPP core network, including retrieval of network capability information, using SCEF and NEF APIs (e.g., an EDGE-2 reference point).

In an example, the edge enablement layer is capable of service provisioning which allows to supply the information required by a WTRU to access the one or more edge services considering the location of the WTRU, one or more service requirements, one or more service preferences and/or connectivity information to provide the configuration information for establishing connectivity with the one or more available EDNs1 and the one or more EESs.

In an example, the edge enablement layer is capable of registration which allows the one or more functional entities such as the WTRU, the EAS and/or the EES to provide information to an associated registration management entity such as the EES and/or the ECS.

In an example, the edge enablement layer is capable of EAS discovery which allows the WTRU to obtain information about one or more suitable EASs of interest as indicated via one or more discovery filters.

In an example, the edge enablement layer is capable of service exposure to the EAS and/or the EEC. This capability allows the edge enablement layer to expose one or more services of the edge enabler layer and of the 3GPP core network to the EAS and the EEC.

In an example, the edge enablement layer is capable of supporting service continuity which allows a WTRU to move to a new location where different EASs can be more suitable for serving the WTRU without experiencing service disruption. The capability also supports transitioning to a cloud application server (CAS) when no edge service can be provided.

In an example, the edge enablement layer is capable of dynamic EAS instantiation which allows the EES to interact with the ECSP management system to trigger dynamic and on-demand instantiation of one or more EASs.

In an example, the edge enablement layer is capable of common EAS discovery which allows common EAS discovery by several WTRUs for the purpose of engaging in one or more collaborative application layer activities.

In an example, the edge enablement layer is capable of bundle EAS which allows to associate multiple EAS for application use cases requiring multiple EASs.

In an example, the edge enablement layer is capable of federation and roaming which allows one or more WTRUs to consume one or more edge services when roaming and allow different networks to communicate edge information with each other.

Energy efficiency (EE) information and/or energy efficiency criteria refers to a set of information related to one or more energy aware services and used for optimization of an application server (e.g., an EAS) discovery. For example, the EE information and/or the energy efficiency criteria includes the information such as, but not limited to: WTRU energy status, battery power level of the WTRU, energy consumed by nodes in the user plane WTRU subscription for one or more energy aware services, one or more energy budgets associated with one or more WTRUs, MNO and/or ASP energy budget, application server energy consumption per service, application server energy consumption rating, indication of average power consumption of the one or more EASs for all running services, application server capability to scale computing up or down to save energy at the WTRU, one or more energy limits set for one or more nodes in the CN, one or more energy limits set for one or more EASs, one or more energy limits set for one or more EESs, one or more energy limits set for one or more data sessions and/or communication sessions etc., source of energy used by the one or more nodes, and/or source of energy used by the one or more EASs etc., for example.

The energy consumption goal information may be described as an energy consumption goal expected by the WTRU and/or a user. The included energy goal information may, for example, indicate that a desired network behavior for an edge service should prioritize lower energy consumption, and/or that the energy goal should privilege performance over energy consumption. An energy goal may be related to the ratio and/or percentage of energy used that is a renewable energy of a total energy used (e.g., including non-renewable and renewable energy). For example, an energy goal can indicate a minimum and/or preferred ratio of used renewable energy of the total energy used.

An energy profile can be associated with an EES and/or an EAS. The energy profile can include information, such as the energy consumption of the EES and/or EAS, the energy source of the EES, EAS and/or the EDN etc. The energy profile may include one or more time windows when a certain energy source type is available, e.g., solar energy and so on. The energy profile may include an indication of a capability to dynamically adjust and/or modify energy consumption based on the one or more energy goals. In an example, if the WTRU and/or an application client indicates change, e.g. change to a lower energy consumption goal for the EES, the EDN and/or the EAS, change to lower battery power in the WTRU then, the EES has the capability to modify energy consumption for the WTRU by changing to an EAS which consumes lower energy and/or by changing to an EAS which can complement a WTRU with low battery power.

The energy profile may include energy adaptation related to adjusting, changing, modifying energy consumption for the EES and/or the EAS. In a simple scenario, one or more instances of the EAS can consume different energy and the EES can select and/or reselect the EAS which fits in the energy consumption budget.

In another example, the EAS may increase or decrease energy consumption by changing a service level. For example, a streaming server may consume more energy if it provides a 4k streaming service. But the streaming server may consume lower energy if it provides lower resolution service like 720p. To meet the energy goal, a streaming server which provides 720p service may be chosen instead of the 4K streaming service provider.

In another example, the EES may select the EAS, which may support the WTRU with the low battery power. In an example, a WTRU with low battery power may be served for longer time and/or may conserve WTRU battery power with lower streaming service instead of higher streaming service.

In an embodiment, the edge enabler layer, which is an application layer, may obtain energy consumption information from the core network energy consumption related to one or more communication aspects, and from the management system (e.g., OAM etc.) for energy consumption related to the computing aspects.

In an embodiment, one or more functional entities of the edge enabler layer may consider one or more energy consumption aspects in various procedures such as but not limited to initial discovery and selection of edge application servers based on energy criteria which may be associated with a user subscription, a configuration, a policy and/or or provided by a WTRU etc., for example.

In an embodiment, an energy consumption information may be monitored for ensuring a continuous energy efficient operation. In an example, continuous monitoring may require the one or more functional entities of the edge enablement layer to perform various actions such as but not limited to triggering an application context relocation (ACR) based on one or more energy consumption requirements and/or to consider energy consumption when an ACR is triggered by the WTRU mobility.

Various embodiments of the present disclosure provide various enhancements to a 3GPP edge enablement layer to support one or more operations based on one or more energy criteria. A method of the present disclosure uses the edge enablement layer and extends the capability of the edge enablement layer to select an EAS based on the one or more energy criteria. The edge enablement layer may be extended to collect energy information from the core network and the OAM system. The edge enablement framework processes the energy information for EAS discovery and selection mechanisms based on energy information. The edge enablement framework may provide service provisioning based on energy information. The service provisioning in the edge enablement layer allows configuring a WTRU client (e.g., an EEC) with information about available edge data networks and associated edge enabler servers. The information is provided by an ECS to the WTRU client and may be determined based, for example, on a WTRU location, one or more WTRU service requirements, a WTRU subscription and/or a WTRU connectivity etc. The configuration information provided to the WTRU client may include the necessary information for the WTRU (e.g., the EEC) to establish a connection with a selected EDN and an EES that is associated with the EDN. The method describes energy information that may be considered in a service provisioning procedure to enable energy aware selection of an EDN and/or an EES that is associated with the EDN.

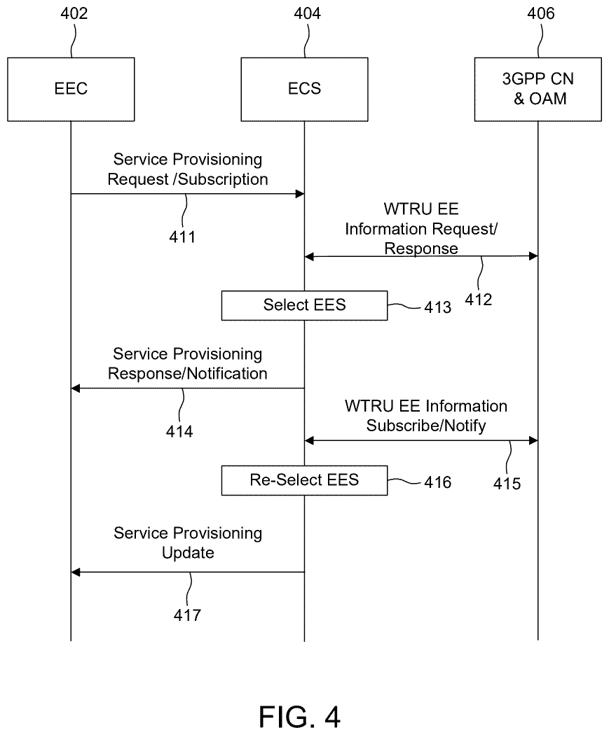

Referring now to FIG. 4, a flow diagram illustrating an example method for service provisioning enhanced with energy information is shown according to one or more embodiments. The method is performed between an EEC 402, an ECS 404, and an OAM node 406. In an example, as a pre-requisite of the method shown in FIG. 4, the ECS 404 may obtain information about one or more available EESs through an EES registration mechanism. One or more EESs that are considered in the procedure of FIG. 4 may be the one or more EESs that are previously registered with the ECS 404.

At 411, the EEC 402 requests for service provisioning information and/or subscribes for service provisioning information changes with the ECS 404. The message sent to the ECS 404 may include information enabling the ECS 404 to make a determination of a suitable EDN and the EES for the requesting WTRU.

The message may include information related to one or more energy consumption goals expected by the WTRU and/or the user.

In an example, the one or more energy consumption goals may be expressed as an energy goal for one or more discovered functional entities. For example, the energy goal may be an energy goal used for identifying the one or more EESs, the one or more EASs and/or may be expressed as an overall EDN energy goal for identifying the EDN where the EES and/or the EAS may reside. In an example, the one or more energy consumption goals may be expressed as an energy goal for the WTRU and/or one or more applications residing on the WTRU. In an example, the one or more energy goals may be expressed as an energy goal for the whole WTRU (e.g., regardless of the application) and/or may be expressed as an energy goal that applies only to a specific application client. In an example, the one or more energy consumption goals may be expressed in one or more units of energy credits and/or one or more energy credits per unit of time.

In an example, the one or more energy goals may indicate a preferred source of energy used by the network. For example, the preferred source of energy may indicate that the identified EES and/or the EDN should be powered by a renewable energy (e.g., solar, wind, tidal, and/or hydro-electric energy etc.).

In an example, the one or more energy goals may indicate one or more desired energy thresholds that may indicate one or more desired energy consumption levels and/or limits. The one or more energy thresholds may indicate minimum, preferred and/or maximum energy consumption limits that the ECS 404 should consider when identifying an EDN and an associated EES. In an example, an energy threshold may be expressed in units of Watts.

In an embodiment, an energy goal may be related to a ratio and/or a percentage of energy used that is a renewable energy of the total energy used (e.g., non-renewable and renewable energy). In this case, one energy goal may indicate a minimum and/or preferred ratios of used renewable energy of the total energy used. In an example, the request may indicate if the energy information is to be used by the ECS for a one-time service provisioning and/or if the energy information should be used for continuous energy monitoring, including monitoring for the EDN and/or one or more EES threshold crossings that may occur in the future. For example, if the request is for one time service provisioning, the ECS 404 may identify an EDN and an associated EES once, whereas if the request indicates continuous monitoring, the ECS may perform a first identification of the EDN and the associated EES, then monitor the identified EDN and/or the identified EES and/or other EDS and/or EES that may cross the one or more threshold limits for energy consumption. If continuous monitoring is requested by the EEC, then the ECS 404 may be triggered to monitor for more energy efficient EDN and/or EES combinations. Monitoring for more energy efficient EDN and/or EES combinations may mean that the ECS 404 subscribes to the core network to receive one or more notifications about the energy consumption that is associated with one or more user plane paths (i.e. data network access identifier (DNAIs)). If the ECS 404 receives a notification that an energy efficient user plane path is available, the ECS 404 may send a service provisioning update message to the EEC 402 to notify the EEC 402 about the availability of the more energy efficient path. The service provisioning update message may trigger the EEC 402 to initiate an ACR procedure and use an EES that is associated with the more energy efficient user plane path.

In an embodiment, the message may include the WTRU battery power level and/or a WTRU prediction of how long the battery is expected to last and/or a WTRU prediction of how long battery will be needed before the WTRU may be recharged. The WTRU battery power level information and the WTRU prediction of how long battery will last may be used by the ECS 404 to select an EDN and/or an EES, which has the capability to support a WTRU operation based on the WTRU battery power level. For a WTRU with low battery power, an EDN and/or EES may be selected which may scale down a quality of service to preserve battery power in the WTRU by selecting an appropriate EAS. For example, if the WTRU battery power is low, then scale down a streaming service from 4K to 720p or lower resolution.

The EEC 402 may also include, if available, information about the expected duration of one or more data sessions of interest. The ECS 404 may use this information to identify the EDN and/or the EES that may serve energy goals related to the WTRU, in the time window of interest.

At 412, the ECS 404 may use the information provided by the WTRU (e.g., the EEC 402) to obtain energy information from the CN and the OAM systems 406.

The ECS 404 may establish a first list by identifying the one or more EDNs and one or more associated EESs based on information provided by the WTRU. The EDN and the associated EES included in the first list may be identified based on one or more non-energy parameters (e.g., a WTRU identifier, a WTRU location information, one or more WTRU AC requirements, one or more WTRU ECSP requirements, etc.) included in the request.

At 413, the ECS 404 may establish a second list of EDN and associated EES from the first list. The second list may be established considering the energy information provided by the WTRU in the request. To determine the second list, the ECS 404 considers energy information from CN and OAM received in 412.

In a first example, the ECS 404 may obtain the energy information from the CN (e.g., via the NEF). The ECS 404 may obtain information about the WTRU subscription. The WTRU subscription information may indicate to the ECS 404 whether the WTRU has subscribed for “energy efficient” operation and may be used by the ECS 404 to determine if the second list should be determined before considering energy information provided by the WTRU. If the WTRU has subscribed for energy aware operation, then the ECS 404 may consider energy information provided by the WTRU (e.g., the EEC) to identify the EDN and associated EES to be included in the second list.

In a second example, the ECS 404 may obtain energy information from the 3GPP management system. The ECS 404 may request energy-related information from the management system by creating one or more management objects using one or more management procedures. The ECS 404 may obtain information about one or more energy limits and source of energy from the OAM, as described in TR 26.942, which is a study item and being developed, for the EES included in the first list. The ECS may use the one or more energy limits information from the management system to determine if one or more EESs included in the first list are within the energy threshold information provided by the WTRU and may include the one or more EESs that are within the threshold in the second list. The ECS 404 may use the energy source information from the management system to determine if the one or more EESs included in the first list are compliant with the preferred source of energy indicated by the WTRU and may include the one or more EESs matching a preferred source of energy in the second list.

The energy information obtained from the core network may be related to energy consumption of one or more user plane paths for the WTRU. For example, if the WTRU has data connection to certain EES and associated EAS, then the energy consumption related to the user plane path for the WTRU may reflect the amount of energy consumed by the core network for the user plane for the data session of interest (established with an EAS associated with an EES). This information may be used by the EES and/or ECS 404 to determine how much energy is consumed in the network for the one or more user plane paths (e.g., using different DNAIs) for the WTRU.

In an example, where the WTRU does not have a current data session with the EES and associated EAS, energy information related to current user plane path for the WTRU may not be available. In this case, the EES and/or the ECS may request to obtain historical information about user plane energy usage for this WTRU in the past, and/or using energy information for user plane for other WTRUs that are similar to this WTRU and currently exchanging traffic with an EAS associated with an EES. Additionally, predicted energy consumption information may be needed.

The predicted energy consumption information may be required from the CN to enable discovery operations considering the one or more energy consumption requirements (e.g. the predicted energy consumption information may refer to energy information about network resource usage before one or more network resources are actually used). An energy information function (EIF) in the CN provides a capability for exposing energy information to an AF such as the ECS via the N110 reference point (e.g., between the EIF and the AF) and/or the N111 reference point (e.g., between the EIF and the NEF). The EIF has a capability to expose energy information related to actual energy consumption information for different granularities such as for a WTRU, for a slice (e.g., single-network slice selection assistance information (S-NSSAI) etc.), for a PDU session and/or for a service data flow. The ECS may invoke an NEF and/or one or more EIF APIs to obtain the energy consumption information.

Thus, in the context of discovering the one or more edge resources considering the energy consumption, the EIF may be required to be enhanced with one or more capabilities for providing the predicted energy consumption information. For example, the EIF calculated energy consumption information may be provided to a network data analytics function (NWDAF) for one or more existing WTRUs (e.g., in different locations and/or for different services) consuming the one or more edge services from the EDN, and/or the NWDAF may use a machine learning (ML) model for predicting energy consumption expected by a different WTRU that is not yet consuming services from that EDN. The EIF and/or the NWDAF may expose the predicted energy consumption information to an AF (e.g., the ECS) via the N110 and/or N111 reference points. The predicted energy consumption information may then be used by the ECS 404 to perform the determination that the EDN and its associated EES meets the energy requirements provided by the WTRU.

At 414, the ECS 404 sends a message to the EEC including the service provisioning information. The ECS 404 may identify one or more EDN and associated EES (e.g., generated a second list) using energy information provided by the WTRU, the CN and the OAM, and send the identified EDN and associated EES information (e.g., send the second list) in the service provisioning response message to the EEC.

The ECS 404 sends the service provisioning response to EEC 402. In the service provisioning response message, the ECS 404 sends a list of the one or more identified EDNs and the one or more associated EESs and may include the energy information (e.g., an energy profile) for each EDN and/or EES obtained via interactions with the CN and/or OAM. The energy profile may include information, such as but not limited to the energy consumption of the EES, the energy source of the EES and EDN and/or an indication of capability to dynamically adjust and/or modify energy consumption based on one or more provided energy goals.

The ECS 404 may associate a ranking information for each EES and/or EDN in a list of the one or more selected EESs and/or EDNs to potentially serve the EEC 402. The ranking may indicate an order of the one or more EESs that are selected by the ECS 404. The ECS 404 may rank the one or more EESs based on their corresponding energy information. For example, the ECS 404 may rank the one or more EESs based on their corresponding energy consumption. In this example, an EES with a higher energy consumption would have a higher-ranking value, meaning not prioritized over an EES with a lower ranking value, meaning lower energy consumption.

The ECS 404 may associate one or more priority values with each of the one or more EESs and/or EDNs in the list of one or more selected EESs and/or EDNs. The priority value may indicate a priority assigned by the ECS 404 using information provided by the EEC 402 and information received from the network (e.g., the CN and the OAM 406).

In an example, the ECS 404 may determine that a first EES1 may incur a low energy consumption EC1 for the EEC application traffic, but has a load that is approaching its capacity, so the EES1 may not be able to serve well the EEC traffic. The ECS 404 may determine that a second EES2 may incur a higher energy consumption EC2 for serving the EEC application traffic, but this EE2 has a lower load so it can serve the EEC application traffic well. The ECS 404 may determine a certain priority for EES1 and EES2 depending on some local policies, network policies, EEC request, energy information goal and so on. Upon receiving the response from the ECS 404, the EEC 402 may perform the selection of an EDN and an associated EES to obtain one or more edge services. The EEC 402 may consider the energy information provided by the ECS 404 to make that selection.

In one example, if the EEC 402 is provided with a list of one or more EESs and/or EDNs and corresponding energy consumption and/or estimated energy consumption for serving the EEC 402 application traffic, then the EEC 402 may determine to select the EES and/or EDN that would incur the lowest energy consumption for the application traffic of the WTRU (e.g., the EEC 402).

In a second example, if the EEC 402 is provided with a ranking and/or a priority value associated with each EES and/or EDN (potentially with or without energy consumption information for each EES), then the EEC 402 may use the ranking and/or priority values for the one or more EESs to select an EES. For example, the EEC 402 may select the EES that has been assigned the lowest priority value and/or lowest ranking value (or for e.g., a highest priority and/or ranking).

The EEC 402 may be provided with a time information related to the list of the one or more EESs and/or EDNs provided to the EEC 402. For example, the ECS 404 may determine and provide the EEC 402 with a time window and/or one or more time slots or for a certain duration, during which the EES is expected to have a certain energy consumption information level. For example, the ECS 404 may provide the EEC 402 with information that EES1 has an expected energy consumption level EC1 during time window [T1 . . . . T2] and/or during time slots [T1 . . . . T3] and [T4 . . . . T5] and/or for a certain duration d. The EEC 402 may determine to select an EES whose energy information is below a certain level for a certain time duration. For example, if the EEC 402 expects that an application traffic lasts 10 minutes in average, then the EEC 402 may select an EES that can provide an energy consumption level less than 5 J for 10 minutes, instead of selecting an EES that can provide an energy consumption level less than 3 J for only 2 minutes, then potentially increasing energy consumption level after that. The EEC 402 may have provided the ECS 404, for example in 411, with information about the expected and/or average duration of application session for the EEC 402 and/or the WTRU application. The ECS 404 may have used this information to include in the list only the one or more EESs which can maintain a certain energy level (e.g., low) for the duration value provided by the EEC 402. The ECS 404 may provide this list to the EEC 402. The ECS 404 may also use information provided by the EEC 402 related to the WTRU battery status, including the expected time the WTRU battery is supposed to last before the device needing to be charged again. The ECS 404 may use this information to determine the EES and/or the EDN of interest, e.g., that can serve the WTRU without draining the WTRU battery faster than the duration left for the battery.

At 415, the ECS 404 may subscribe to a core network node and/or the OAM 406 to be notified about availability of new and/or changes in existing EDN and/or associated EES energy information. The ECS 404 may monitor the energy information from the CN and/or the OAM 406 to notify the WTRU about one or more energy related changes.

At 416, the ECS 404 may have identified the one or more EDNs and/or the one or more associated EESs using energy consumption information provided by the CN and/or the OAM 406, which may better serve the WTRU. For example, an EES that has crossed a certain threshold in energy consumption (e.g., an energy limit) may not be suitable for the WTRU.

At 417, the EEC 402 is notified by the ECS 404 about one or more changes in service provisioning information, including an updated energy information. The actions taken by the EEC 402 may be similar to the EEC actions described in 414, and may additionally include triggering an application context relocation for a selected EDN and/or EES based on the updated energy information.

In various embodiments, a method for EES registration with energy information is discussed. An EES registration procedure allows an EES to provide information to an ECS to enable provisioning of EES information to an EEC and/or other EESs. The EES registration update procedure allows an EES to update the ECS, if there is a change in the information at the EES. An energy information related to communication with an EES is in scope of the CN and is obtained from the CN. The energy information obtained from the CN may include energy information related to a user plane path of a WTRU and/or an application traffic of interest. An energy information related to processing performed by an EES is in scope of the OAM and is obtained from the OAM.

As such, an enhanced and/or updated EES registration procedure includes indication of one or more capabilities for supporting one or more energy goals at the EES and/or at the EAS registered with the EES. This information may be stored by EES or the ECS or a combination thereof and this information may be used by the ECS to identify the EES that can meet the one or more energy goals of the WTRU and/or the application client. The one or more capabilities for supporting the one or more energy goals may include an indication if energy information is supported for a given EES identifier and/or an EAS identifier, an indication that energy consumption measurement may be exposed for a given EES identifier and/or an EAS identifier, and an indication whether one or more dynamic energy adaptations based on the one or more energy goals, such as adjusting compute capability of EAS, are supported for a given EES identifier and/or an EAS identifier.

For example, during the enhanced and/or updated EES registration procedure, the EES may indicate to the ECS that the EES supports monitoring energy consumption of a data session. During the EES registration procedure, the EES may also indicate to the ECS that the EES supports triggering an ACR procedure based on the energy consumption information. Monitoring energy consumption information may refer to subscribing to an energy information function (EIF) to receive information about the energy consumption and receiving one or more notification messages from the EIF about the energy consumption. The energy consumption information received from the EIF may include an estimate of the energy consumption for a certain user plane path for the WTRU.

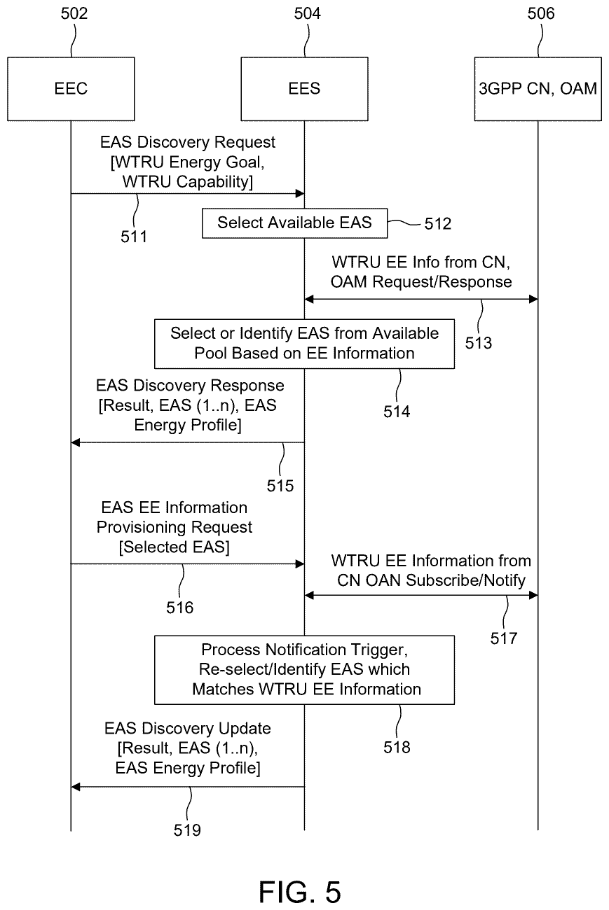

Referring now to FIG. 5, a flow diagram for an example enhanced EAS discovery procedure with energy information is shown according to one or more embodiments. The procedure is performed between an EEC 502, an EES 504, and an OAM 506.

In an example, as a pre-requisite of the procedure shown in FIG. 5, that the EES 504 has obtained information about one or more available EASs through an EAS registration mechanism, and that the one or more EASs considered in the procedure shown in FIG. 5 are the one or more EASs that have previously registered with the EES 504.

At 511, The EEC 502 sends an EAS discovery request to the EES 504. The EAS discovery request includes a requestor identifier [EECID] and/or one or more security credentials and may further include one or more EAS discovery filters, an EEC service continuity support, and may also include a WTRU location to retrieve information about one or more particular EASs and/or a category of EASs. If the EEC 502 is energy aware, then the EAS discovery request may include additional energy related information, and this information may be included in the EAS discovery filter. The EAS discovery request may include an indication that an EAS selection may be based on the energy information that is included in the EAS discovery request. The EAS discovery request may include energy consumption goal information indicative of one or more energy consumption goals expected by the WTRU and/or the user. The energy consumption goal information may, for example, indicate that a desired EAS behavior for an edge service should prioritize lower energy consumption, and/or that the energy goal should privilege performance over energy consumption. The one or more energy consumption goals may be expressed as an energy goal for one or more discovered functional entities. For example, the energy goal may be an energy goal used for identifying the one or more EASs and/or may be a combined energy goal for a group of EASs when discovering an EAS bundle. It can be appreciated that the energy consumption goal may be expressed as an energy goal for the WTRU and/or one or more applications residing on the WTRU. For example, the energy goal may be expressed as the energy goal that applies for the whole WTRU (e.g., regardless of the application) and/or may be expressed as the energy goal that applies only to a specific application client (AC). The one or more energy goals may indicate one or more desired energy thresholds that may indicate one or more desired energy consumption levels and/or limits. The one or more energy thresholds may indicate minimum, preferred and/or maximum energy consumption limits that the EES 504 should consider when identifying the one or more EASs.

The EAS discovery request may indicate if the energy information is to be used by the EES 504 for a one-time EAS discovery or if the energy information should be used for continuous energy monitoring, including monitoring for the one or more EAS threshold crossings that may occur in the future. For example, if the request is for one time service provisioning, the EES 504 may identify EAS once, whereas if the request indicates a continuous monitoring, the EES 504 may perform a first identification of EAS, then monitor the identified EAS and/or other EASs that may cross the one or more threshold limits for energy consumption.

It may be appreciated that one aspect of the energy goal may indicate a preferred source of energy used by the EAS. For example, the preferred source of energy may indicate that the identified EAS should be powered by renewable energy (e.g., solar, wind, tidal, and/or hydro-electric etc.). The request may also include a ratio and/or percentage of a minimum ratio of energy being used coming from a renewable energy source versus a total energy used by the EAS (e.g., including the non-renewable and the renewable energy sources).

The EAS discovery request may include an indication related to one or more WTRU energy capabilities; for example a capability to offload compute from the WTRU to the EAS to save energy, a capability of the WTRU to adjust its own compute level to conserve energy while maintaining a minimum service level allowing an EAS to step down to lower computation level and save energy, the WTRU may have a capability to change an access technology (e.g. use multipath, change to non-3gpp etc.), to preserve energy. The WTRU may lower energy usage by switching to non-3gpp access and may use the saved energy for high quality service. The WTRU may consume high quality service by selecting an EAS, which may provide high quality service, e.g. streaming at 4k.

The EES 504 may consider the WTRU capability when identifying the one or more EASs. The EAS discovery request may include WTRU battery power level and/or a WTRU prediction of how long the battery is expected to last and/or a WTRU prediction of how long battery will be needed before the WTRU may be recharged.

At 512, the EES 504 may establish a first list by identifying the one or more EASs based on information provided by the WTRU. The one or more EASs included in the first list may be identified based on one or more non-energy parameters included in the EAS discovery request.

At 513, the EES 504 may use the information provided by the WTRU (e.g., the EEC) to obtain energy information from the CN and the OAM systems 506 about the EAS identified in the first list.

In an example, the EES 504 may obtain the energy information from the CN (e.g., via a network exposure function (NEF)). The EES 504 may obtain information about a WTRU subscription. The WTRU subscription information may indicate to the EES 504 whether the WTRU has subscribed for one or more energy saving services and may be used by the EES 504 to determine if a second list should be established before considering energy information provided by the WTRU. If the WTRU has subscribed for the one or more energy saving services, then the EES 504 may consider energy information provided by the WTRU (e.g., the EEC 502) to identify the one or more EASs to be included in a second list.

The EES 504 may obtain, from the CN, total energy consumption information for a WTRU to setup a user plane to an EDN. This may be an aggregate for one or more nodes in the user plane connecting to the EDN. Alternatively or additionally, the EES 504 may obtain, from the CN, for the WTRU, energy consumed in each node, involved in the user plane towards the EDN. The access to the core network node energy consumption information related to the WTRU may be subject to authorization by the core network for the EES to request such information. Otherwise, the EES 504 may still obtain the energy consumption estimate for the user plane path, without each network node energy information.

The EES 504 may obtain from the CN, one or more energy consumption budgets, for the WTRU. This provides information for the WTRU, about one or more energy budget thresholds for one or more levels of services. The WTRU may be allowed to consume energy within the energy budget thresholds. An EAS is selected if the energy consumption of the EAS can be accommodated within the energy budget of the user. A user can be allowed to consume more energy for high quality service at a cost. On the other hand, a user can use lower energy for certain level of degradation of service and can be rewarded.

In an example, the EES 504 may obtain energy information from the 3GPP management system, e.g., the OAM 506. The EES 504 may request energy-related information from the OAM 506 by creating one or more management objects used in one or more management procedures.

The EES 504 may obtain information about one or more energy limits and/or one or more sources of energy for the one or more EASs included in the first list from OAM 506.

A predicted energy consumption information may be required from the CN to enable a discovery operation considering the one or more energy consumption requirements (e.g. before edge resources are actually used). The EIF in the CN provides a capability for exposing the energy information to an AF such as the EES via an N110 reference point (e.g., between the EIF and the AF) and/or an N111 reference point (e.g., between the EIF and the NEF). The EIF has a capability to expose energy information related to actual energy consumption information for different granularities such as for a WTRU, for a slice (e.g., S-NSSAI), for a protocol data unit (PDU) session and/or for a service data flow.

In a context of discovering one or more edge resources considering the energy consumption, the EIF may be enhanced with one or more capabilities for providing the predicted energy consumption information. For example, the EIF calculated energy consumption information may be provided to a network data analytics function (NWDAF) for one or more existing WTRUs (e.g., in different locations and/or for different services etc.) consuming edge services from an EAS, and the NWDAF may use a ML model for predicting energy consumption expected by a different WTRU that is not yet consuming services from that EAS. The EIF and/or the NWDAF may expose the predicted energy consumption information to an AF (e.g. the EES 504) via the N110 and/or N111 reference points. The predicted energy consumption information may then be used by the EES 504 to perform the determination that an EAS meets the energy requirements provided by the WTRU.

In the case of continuous energy monitoring by the EES 504, the EES 504 may determine with the assistance of the core network, a certain reporting frequency within a certain time unit, to avoid receiving too many energy consumption notifications in a short amount of time for the WTRU and/or the EEC 502 of interest. The EES 504 may interact with the core network, such as the EIF directly or via the NEF, to determine the energy monitoring maximum reporting frequency within a time unit per WTRU and/or EEC 502.

At 514, the EES 504 may use the one or more energy limits information received from the management system (e.g., the OAM 506) to determine if the one or more EASs included in the first list are within the energy threshold information provided by the WTRU and may include the one or more EASs that are within the threshold in a second list. The EES 504 may use the energy source information from the management system to determine if the one or more EASs included in the first list are compliant with the preferred source of energy indicated by the WTRU and may include set of EASs matching a preferred source of energy in a second list.

The EES 504 may store the energy information provided by the WTRU in 511 and the EAS energy information obtained from the CN and the management system (e.g., the OAM 506). The EES 504 may derive a predicted energy consumption per EAS for the requesting WTRU. For example, the EES 504 may combine the predicted energy consumption information provided by the CN for the WTRU to communicate with the EAS in a given EDN with the actual energy consumption for the same EAS provided by the management system to determine whether the EAS meets the one or more energy consumption requirements requested by the WTRU.

In 515, the EES 504 may send a message to the EEC 502 including the EAS discovery information. The EES 504 may have identified the set of EASs (e.g., generated the second list) using the energy information provided by the WTRU, the CN and the OAM 506, and may send information associated with the identified set of EASs (e.g., sends the second list) in the EAS discovery response message to EEC 502.

The EES 504 sends the EAS discovery response to EEC 502. In the EAS discovery response, the EES sends a list of a set of identified EASs and may include the energy information (e.g., an energy profile) for each EAS obtained via interactions with the CN and/or OAM 506. The energy profile may include information, such as but not limited to the energy consumption of the EAS, the energy source of the EAS and an indication of capability to dynamically adjust and/or modify energy consumption based on the one or more provided energy goals.

If the EEC 502 indicated in 511 that a certain energy level with a threshold value is preferred and/or that a certain energy aware behavior from the EES 504 and/or EAS is preferred, then the ECS and/or the EES 504 may use the one or more energy consumption threshold values as a soft threshold. For example, if a certain EES and associated EAS has only 40% of the energy consumption stemming from a renewable source, and the EEC 502 included a preferred ratio of 50%, then the ECS and/or EES 504 may determine to still include the EES 504 and/or the EAS in the list to be provided to the EEC 502, as the ratio was a preferred ratio, and not a strict requirement. In the same context, the EEC 502 may provide one or more preferred values and one or more required values for one or more energy goals and related information. For example, the EEC 502 may indicate that a maximum average energy consumption of 5J is expected and/or preferred for the data session in a certain time interval and may also indicate that an average energy value of more than 8 J is not acceptable. The EES 504 may provide the EEC 502 with an information about the category under which certain EAS falls, in relation to energy goal or information. For example, the EES 504 may indicate that certain EAS1 may fall under a low energy consumption category, and another EAS2 may fall under a medium energy consumption category.

The EES 504 may further provide which EAS1 is more suitable for the EEC 502 and the WTRU when the WTRU battery status is in a certain level. For example, the EES 504 may indicate to the EEC 502, that for a WTRU battery level under 30%, EAS1 is recommended to be used and/or selected, whereas for a WTRU battery level over 30% or when the WTRU is plugged, then the EAS2 would be more suitable for the WTRU, as, for example, it may improve the quality of service for the EEC or WTRU application, while not incurring a much higher energy consumption. The EEC 502 may use this information to determine, based on the WTRU battery status, which EAS from the list of one or more EASs to select and update the EES 504 accordingly. Upon receiving the response from the EES 504, the EEC 502 may perform the selection of an EAS to obtain edge services. The EEC 502 may consider the energy information provided by the EES to make that selection.

At 516, the EEC may send the EAS information provisioning request to the EES 504 for indicating the EAS instance that was selected by the EEC 502. The EES 504 may use the selected EAS information provisioning to further interact with the CN and management system as described in 517 and 518.

In 517, the EES 504 may receive EAS EE information provisioning request from the WTRU. The request indicates that the EES 504 should monitor energy consumption information of the selected EAS. The request may include information about the EAS selected by the WTRU. The EES 504 may use this information to subscribe with the CN for obtaining actual energy consumption for the WTRU communicating with the selected EAS and may subscribe with the management system to obtain energy consumption for the selected EAS. These subscriptions may provide the EES 504 with actual energy consumption information and may allow the EES 504 to monitor the energy consumption actuals for a given WTRU.

At 518, the actual energy consumption between a WTRU and a selected EAS may be compared to the energy information (e.g., the one or more goals and/or thresholds, etc.) received from the WTRU in 511 for the purpose of dynamically monitoring the energy consumption.

At 519, the EES 504 may send a notification to the EEC 502 when the actual energy consumption changes and/or when the energy consumption crosses a provided threshold. This notification may be used by the EEC 502 to re-consider using the selected EAS and may be used by the EEC 502 to trigger an application context relocation, for example if the high energy consumption threshold is crossed.

When the WTRU has one or more capabilities that may benefit and/or assist with having a lower energy consumption and/or better performance and medium energy consumption using a certain EES and/or EAS, such as a capability to offload traffic to a certain nearby entity, and/or being able to leverage a non-3GPP access to exchange data, then if the EEC 502 provides a similar information to the EES 504, for example that offloading and non-3GPP access may be used for energy purposes, then the EES 504 may need to check with the core network whether the WTRU that is hosting the WTRU application and the EEC 502, is allowed to use such capabilities, and whether there is any restriction in terms of location, network status and/or policy, that prevents the WTRU from using this capability, at some point, and hence prevents the EES 504 and/or EAS from leveraging this capability. When the EES 504 verifies that the WTRU and EEC 502 are authorized to use such as network capabilities, then the EES 504 may use such capabilities to be configured and/or configure the EAS with a behavior that can leverage these capabilities.

Various embodiments provide one or more procedures for triggering an ACR based on energy information.

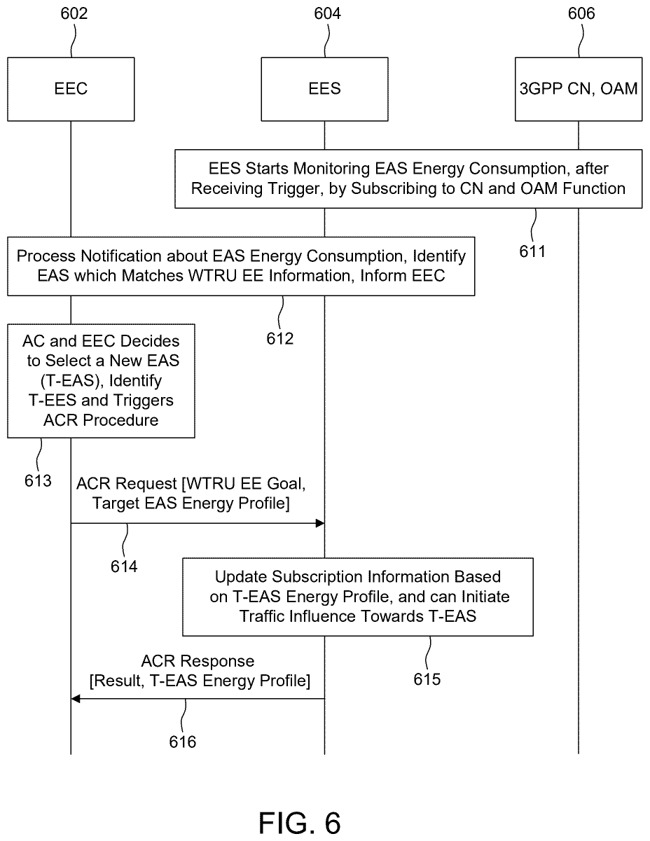

Referring now to FIG. 6, a flow diagram of an enhanced EAS discovery procedure with energy information is shown according to one or more embodiments. The procedure if performed between an EEC 602, an EES 604, and an OAM 606. In an example, in the procedure of FIG. 6, the EES 604 may monitor the energy consumption information that is associated with the usage of one or more network resources by the EEC 602 and determine whether to trigger an ACR procedure based on the energy consumption information.

At 611, for example, the EES 604 may receive information from the EEC 602 and/or the EAS about a data session between the EEC 602 and/or the EAS. The information about the data session may include an internet protocol (IP) address and one or more port numbers of the EEC and may include an IP address and one or more port numbers of the EAS. The EEC 602 and/or the EAS may request that the EES monitor the energy consumption information that is associated with data session. The EEC 602 and/or the EAS may request that the EES trigger an ACR procedure based on the energy consumption information that is associated with the data session, when exceeds a threshold. The EEC 602 and/or EAS may provide the threshold to the EES 604. The request from the EEC 602 and/or the EAS may trigger the EES to subscribe to a core network to receive notifications about the energy consumption information that is associated with data session. The subscription request that is sent by the EES 604 to the core network may include the IP address and the one or more port numbers of the EEC 602 and may include an IP address and the one or more port numbers of the EAS. The subscription request may be sent to an EIF in the core network and the subscription request may be sent to the EIF via the NEF.

The EES 604 may receive one or more notifications from the core network (e.g. the EIF). The notification may include the energy consumption information that is associated with the data session. The EES 604 may compare the energy consumption information to the threshold value and, based on the energy consumption information being above the threshold, decide to trigger an ACR procedure. In other words, the EES 604 may determine that the data session between the EEC 602 and the EAS is consuming too much energy. The EES 604 may initiate an ACR procedure to change the data session so that it goes from the EEC 602 to a second EAS. The original EAS may be the S-EAS and the second EAS may be the T-EAS. The EES 604 may determine the identity of T-EAS based on the location of the WTRU that hosts the EEC 602 and based on energy prediction information that is received from the core network (i.e. the EIF). For example, detecting that the energy consumption of the data session between the EEC 602 and S-EAS may be indicative of the WTRU being too far from the S-EAS. Being too far from the S-EAS may refer to the EEC 602 being geographically far from the S-EAS and/or may refer to the EEC 602 being in a location where the networking path between the EEC 602 and the S-EAS is long. Thus, identity of the T-EAS may be determined by the EES 604 based on the geographical distance between the EEC 602 and T-EAS and/or an estimated length of the networking path between the EEC 602 and T-EAS is long.

At 612, As described in FIG. 5, the EES 604 may additionally identify one or more new EASs that meet the one or more energy consumption goals of the WTRU and may notify the WTRU about the availability of one or more new EASs. The WTRU may consider whether to select and trigger an ACR when informed of new EAS availability considering the energy consumption. It may further be appreciated that the EES 604 may inform the WTRU about actual energy consumption of the previously discovered EAS.

At 613, the EEC 602 may determine to trigger an ACR procedure for the selected EAS; the ACR procedure decision may be triggered by a notification indicating an energy consumption degradation or the indication of an EAS with a better energy consumption. The EEC 602 may select a new EAS (e.g., a target EAS) based on one or more energy metrics.

614, the EEC 602 triggers the ACR by sending an ACR request message to the EES indicating the newly selected EAS (e.g., the target EAS) and the energy profile of target EAS.

In 615, the EES 604 receives ACR request from EEC 602 and may verify if the target EAS still meets the one or more desired energy metrics. The EES 604 may request energy consumption information of the target EAS from the CN and verify if the energy consumption criteria is met. If it is met, the EES 604 may perform the transfer of the EAS and EEC contexts to the target EAS and target EES respectively. If the EES had subscribed for energy information in 611, the EES 604 updates such subscription considering the target EAS. If the one or more target EAS energy metrics are not met, then the EES 604 may not perform the transfer of the EAS and EEC contexts.

At 616, the EES 604 sends an ACR response to EEC 602, indicating that the ACR procedure is either successful or failed, with the target EAS and sends a target EAS energy profile.

In various embodiments, the enhanced EAS registration procedure with energy consumption information allows an EAS to provide information to an EES to enable discovery of EAS information by the EEC and/or one or more other EESs. The EAS registration update procedure allows an EAS to update the EES, if there is a change in the information at the EAS. In an example, energy information related to communication with an EAS is in scope of the CN and is may be received from the CN. In an example, energy information related to processing performed by an EAS is in scope of an OAM and may be obtained from the OAM. As such, the EAS registration procedure is enhanced and/or updated to include indication of one or more capabilities for supporting one or more energy goals at the EAS. This information may be stored by the EAS or the EES or a combination thereof and this information may be used by the EES to identify the EAS that can meet the one or more energy goals. The energy information may be part of an EAS profile. The EAS profile may indicate one or more capabilities for supporting the one or more energy goals, may include an indication if exposure of energy information, such as source of energy, average energy consumption, and/or energy rating is supported for a given EAS identifier, an indication that energy consumption measurement may be exposed for a given EAS identifier.

The EAS may provide energy information and energy consumption information, i.e. an EAS profile, to the EES while registering with the EES. For example, the EAS profile provided in the registration request may include one or more energy sources used, which may be used to select EAS, if specified in the WTRU energy goal by the WTRU. If the one or more energy goals specify that the EAS may be selected if it uses renewable energy only, then if in the EAS profile, it is mentioned that energy source is renewable energy only then the EAS is selected by the EES. The EAS energy profile may include information about the time of day when energy cost is cheaper. The WTRU energy goal may indicate selecting EAS when energy cost is cheaper. The EES may select the EAS, if the cost of energy is cheap at that time of day. The EAS profile may provide information about the estimated energy consumption per session and/or an energy consumption limit. WTRU energy goal may indicate the maximum energy consumption budget. The EES may select the EAS if the estimated energy consumption fits within the WTRU energy consumption budget. The EES may select the EAS, if the estimated energy consumption does not cross the energy consumption limit.

The EAS profile may indicate a capability to change service level dynamically based on WTRU power and/or battery level, e.g. high level service (e.g. 4K streaming) when WTRU has more battery power, moderate level of service (e.g. 720p streaming) when WTRU has moderate or low battery power. If WTRU energy goal indicates that the WTRU desires to conserve battery for long period of time, and/or the WTRU has certain battery power and will like to conserve and/or continue using the WTRU for certain amount of time before next charging opportunity, then EES may select an EAS which can adjust and/or modify service level based on the WTRU battery power.

It may be the case that more than one WTRU and EEC on the WTRU are about to be setup to exchange data with a certain service provided by the EAS. It may be the case that a group of WTRUs may be interested to access the same EAS for various data sessions of interest, e.g., a gaming session. In this case, the WTRU or more than one WTRUs may request from the EES to obtain a list of common EASs that can be used by the group of WTRUs and that satisfies the energy related information and/or goal. In this case, the EES may determine a list of EASs that are at the same time common to be used by the group of WTRUs, and that satisfy the energy goal.

The EES may determine that an aggregate energy consumption estimate for the group of WTRUs needs to be obtained, either once or recurrently, using a subscription to the core network, for example. For example, if there are 5 WTRUs that are interested to have various data sessions using a common EAS (or common DNAI), each WTRU may have a certain energy consumption goal, for example, not exceeding 5 J in a certain time window. Alternatively, or additionally, the group of WTRUs may have a certain energy consumption goal. For example, the EES may have an indication that the group of 5 WTRUs may have an aggregate energy consumption not exceeding 22 J in a certain time window. The EES may determine that a certain EAS is suitable for the group of WTRUs if the EAS can support the one or more energy preferences provided by the EEC hosted by the group of WTRUs. The EAS may be suitable for the group of WTRUs if the EAS has a capacity in terms of resource either processing and/or one or more energy resources, that can serve the group of WTRUs.

The EES may determine to obtain energy related information related to the group of WTRUs, including estimates of a user plane path energy consumption, and to obtain EAS energy consumption and load level information from the OAM. The EES may use this information to determine whether the EAS may be suitable for the group of WTRUs. The EES may then send the list of EASs that can be used as a common EAS (and/or common DNAI), to be used by the group of WTRUs at the same time for the data sessions. The WTRUs and/or the EEC hosted by the group of WTRUs may determine a common EAS from the list of EASs to be used.

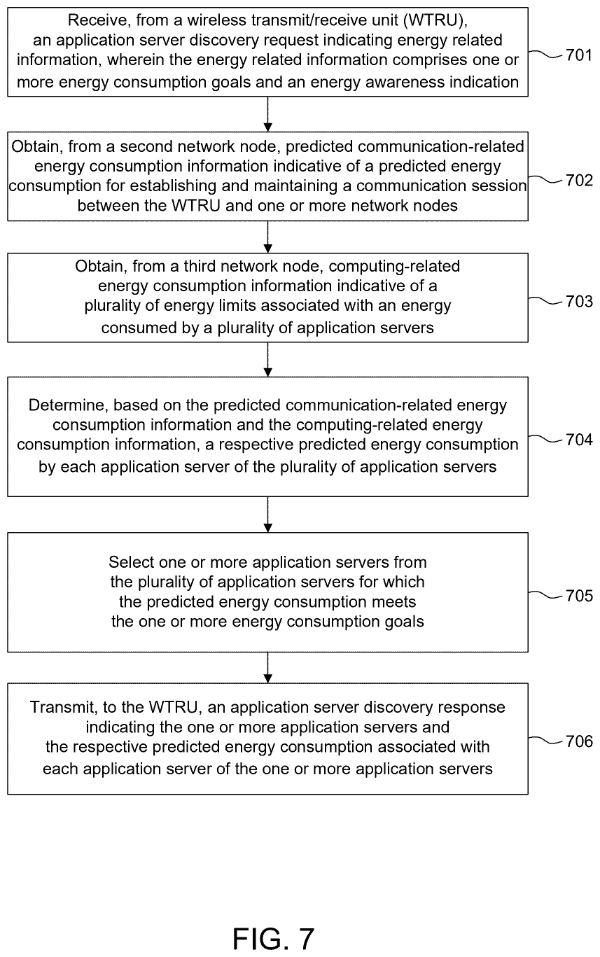

Referring now to FIG. 7, a flow chart illustrating an example application server discovery process is shown according to one or more embodiments. The application server discovery process may be performed by a first network node. In an example, the first network node may be an edge enabler node such as an EES.

At 701, the first network node may receive an application server discovery request from a WTRU. In an example, the WTRU may include an EEC. The application server discovery request may indicate energy related information. The energy related information may comprise one or more energy consumption goals and an energy awareness indication. The one or more energy consumption goals include one or more of: an energy goal for the WTRU, an energy goal for an application server, or a preferred source of energy used by the application server. The energy awareness indication includes one or more of: an indication of one or more WTRU energy capabilities, an indication for selecting an energy aware application server, an indication of one-time provisioning of the first network node, or an indication of continuous monitoring.

At 702, the first network node may obtain predicted communication-related energy consumption information from a second network node. The predicted communication-related energy consumption information may be indicative of a predicted energy consumption for establishing and maintaining a communication session between the WTRU and one or more network nodes.

At 703, the first network node may obtain computing-related energy consumption information from a third network node. In an example, the third network node may be a management node. The computing-related energy consumption information may be indicative of a plurality of energy limits associated with an energy consumed by a plurality of application servers.

At 704, the first network node may determine, based on the predicted communication-related energy consumption information and the computing-related energy consumption information, a respective predicted energy consumption by each application server of the plurality of application servers.

At 705, the first network node may select one or more application servers from the plurality of application servers for which the predicted energy consumption meets the one or more energy consumption goals.

At 706, the first network node transmits, to the WTRU, an application server discovery response indicating the one or more application servers and the respective predicted energy consumption associated with each application server of the one or more application servers. The first network node may receive an application server provisioning request from the WTRU. The application server provisioning request may indicate a selected application server from the one or more application servers.

The first network node may determine that the energy awareness indication includes an indication of continuous monitoring. The first network node may receive an actual communication-related energy consumption information from the second network node. The actual communication-related energy consumption information may be indicative of an actual energy consumed by the one or more network nodes in establishing and maintaining a communication session between the WTRU and an application server. The first network node may receive, from the third network node, an actual computing-related energy consumption information indicative of an actual energy consumed by the selected application server in the communication session. The first network node may continuously monitor an actual energy consumption associated with the communication session based on the actual communication-related energy consumption information and the actual computing-related energy consumption information.

The first network node may compare the actual energy consumption associated with the communication session with an energy limit associated with the communication session. The first network node may transmit a notification to the WTRU when the actual energy consumption associated with the communication session exceeds the energy limit associated with the communication session.

The first network node may receive an ACR request from the WTRU. The ACR request may include an indication of a target application server and an energy profile associated with the target application server. The first network node may determine that the predicted energy consumption associated with the target application server meets the one or more energy consumption goals. The first network node may transfer a context associated with the first network node (e.g., a source EES context) to a target edge enabler server associated with the target application server. The first network node may transfer a source application server context associated with the source application server to the target application server. The first network node may transmit an ACR response to the WTRU. The ACR response may indicate a successful ACR procedure.

The first network node may transmit a registration request to an edge configuration server. The registration request may include an indication of support for one or more energy aware services.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a first network node, the method comprising:
receiving, from a wireless transmit/receive unit (WTRU), an application server discovery request indicating energy related information, wherein the energy related information comprises one or more energy consumption goals and an energy awareness indication;
obtaining, from a second network node, predicted communication-related energy consumption information indicative of a predicted energy consumption for establishing and maintaining a communication session between the WTRU and one or more network nodes;
obtaining, from a third network node, computing-related energy consumption information indicative of a plurality of energy limits associated with an energy consumed by a plurality of application servers;
determining, based on the predicted communication-related energy consumption information and the computing-related energy consumption information, a respective predicted energy consumption by each application server of the plurality of application servers;
selecting one or more application servers from the plurality of application servers for which the predicted energy consumption meets the one or more energy consumption goals; and
transmitting, to the WTRU, an application server discovery response indicating the one or more application servers and the respective predicted energy consumption associated with each application server of the one or more application servers.

2. The method of claim 1, wherein the one or more energy consumption goals include at least one of:
an energy goal for the WTRU,
an energy goal for an application server, or
a preferred source of energy used by the application server.

3. The method of claim 1, wherein the energy awareness indication includes at least one of:
an indication of one or more WTRU energy capabilities,
an indication for selecting an energy aware application server,
an indication of one-time provisioning of the first network node, or
an indication of continuous monitoring.

4. The method of claim 3, further comprising:
receiving, from the WTRU, an application server provisioning request indicating a selected application server from the one or more application servers.

5. The method of claim 4, further comprising:
determining that the energy awareness indication includes an indication of continuous monitoring;
receiving, from the second network node, an actual communication-related energy consumption information indicative of an actual energy consumed by the one or more network nodes in establishing and maintaining the communication session between the WTRU and an application server;
receiving, from the third network node, an actual computing-related energy consumption information indicative of an actual energy consumed by the selected application server in the communication session; and
continuously monitoring an actual energy consumption associated with the communication session based on the actual communication-related energy consumption information and the actual computing-related energy consumption information.

6. The method of claim 5, further comprising:
comparing the actual energy consumption associated with the communication session with an energy limit associated with the communication session; and
transmitting a notification to the WTRU when the actual energy consumption associated with the communication session exceeds the energy limit associated with the communication session.

7. The method of claim 6, further comprising:
receiving, from the WTRU, an application context relocation (ACR) request including an indication of a target application server and an energy profile associated with the target application server;
determining that the predicted energy consumption associated with the target application server meets the one or more energy consumption goals;
transferring a context associated with the first network node to a target edge enabler server associated with the target application server;
transferring a source application server context associated with the selected application server to the target application server; and
transmitting, to the WTRU, an ACR response indicative of successful ACR procedure.

8. The method of claim 1, further comprising:
transmitting, to an edge configuration server, a registration request including an indication of support for one or more energy aware services.

9. The method of claim 1, wherein the first network node is an edge enabler server.

10. The method of claim 1, wherein the WTRU includes an edge enabler client.

11. A first network node comprising:
a transceiver; and
a processor, wherein the transceiver and the processor are configured to:
receive, from a wireless transmit/receive unit (WTRU), an application server discovery request indicating energy related information, wherein the energy related information comprises one or more energy consumption goals and an energy awareness indication,
obtain, from a second network node, predicted communication-related energy consumption information indicative of a predicted energy consumption for establishing and maintaining a communication session between the WTRU and one or more network nodes,
obtain, from a third network node, computing-related energy consumption information indicative of a plurality of energy limits associated with an energy consumed by a plurality of application servers,
determine, based on the predicted communication-related energy consumption information and the computing-related energy consumption information, a respective predicted energy consumption by each application server of the plurality of application servers,
select one or more application servers from the plurality of application servers for which the predicted energy consumption meets the one or more energy consumption goals, and
transmit, to the WTRU, an application server discovery response indicating the one or more application servers and the respective predicted energy consumption associated with each application server of the one or more application servers.

12. The first network node of claim 11, wherein the one or more energy consumption goals include at least one of:
an energy goal for the WTRU,
an energy goal for an application server, or
a preferred source of energy used by the application server.

13. The first network node of claim 11, wherein the energy awareness indication includes at least one of:
an indication of one or more WTRU energy capabilities,
an indication for selecting an energy aware application server,
an indication of one-time provisioning of the first network node, or
an indication of continuous monitoring.

14. The first network node of claim 13, wherein the transceiver and the processor are configured to:
receiving, from the WTRU, an application server provisioning request indicating a selected application server from the one or more application servers.

15. The first network node of claim 14, wherein the transceiver and the processor are configured to:
determine that the energy awareness indication includes an indication of continuous monitoring,
receive, from the second network node, an actual communication-related energy consumption information indicative of an actual energy consumed by the one or more network nodes in establishing and maintaining the communication session between the WTRU and an application server,
receive, from the third network node, an actual computing-related energy consumption information indicative of an actual energy consumed by the selected application server in the communication session, and
continuously monitor an actual energy consumption associated with the communication session based on the actual communication-related energy consumption information and the actual computing-related energy consumption information.

16. The first network node of claim 15, wherein the transceiver and the processor are configured to:
compare the actual energy consumption associated with the communication session with an energy limit associated with the communication session, and
transmit a notification to the WTRU when the actual energy consumption associated with the communication session exceeds the energy limit associated with the communication session.

17. The first network node of claim 16, wherein the transceiver and the processor are configured to:
receive, from the WTRU, an application context relocation (ACR) request including an indication of a target application server and an energy profile associated with the target application server;
determine that the predicted energy consumption associated with the target application server meets the one or more energy consumption goals;
transfer a context associated with the first network node to a target edge enabler server associated with the target application server;
transfer a source application server context associated with the selected application server to the target application server; and
transmit, to the WTRU, an ACR response indicative of successful ACR procedure.

18. The first network node of claim 11, wherein the transceiver and the processor are configured to:
transmit, to an edge configuration server, a registration request including an indication of support for one or more energy aware services.

19. The first network node of claim 11, wherein the first network node is an edge enabler server.

20. The first network node of claim 11, wherein the WTRU includes an edge enabler client.
